(19) United States
(12) Patent Application Publication
(10) Pub. No.: US 2025/0309226 A1
(43) Pub. Date: Oct. 2, 2025

(54) MANUFACTURING METHOD OF SOLID-STATE BATTERY

(71) Applicant: HONDA MOTOR CO., LTD., Tokyo (JP)

(72) Inventors: Takashi TOYOSHIMA, Saitama (JP); Kenta UMETSU, Saitama (JP)

(21) Appl. No.: 19/064,841

(22) Filed: Feb. 27, 2025

(30) Foreign Application Priority Data
Mar. 30, 2024 (JP) 2024-058352

(51) Int. Cl. H01M 4/04; H01M 4/02; H01M 10/04

(52) U.S. Cl. CPC H01M 4/043; H01M 10/0481; H01M 2004/027; H01M 2004/028

(57) ABSTRACT

A manufacturing method for a solid-state battery includes: a negative electrode-side sheet member forming step; a positive electrode-side sheet member forming step; and an integrating pressing step, in which the negative electrode-side sheet member forming step includes: a negative electrode-side solid electrolyte layer transferring step of at least pressing and transferring the negative electrode-side solid electrolyte layer to the negative electrode current collector, and a negative electrode-side sheet member cutting step, and the positive electrode-side sheet member forming step includes a positive electrode pressing step of at least pressing a positive electrode current collector and a positive electrode active material layer, in which a first solid electrolyte layer is provided to a surface of the positive electrode-side sheet member opposing the negative electrode-side solid electrolyte layer prior to the integrating step, and the negative electrode-side solid electrolyte layer has a smaller content of binder than the first solid electrolyte layer.

This application is based on and claims the benefit of priority from Japanese Patent Application No. 2024-058352, filed on 30 Mar. 2024, the content of which is incorporated herein by reference.

### BACKGROUND OF THE INVENTION

### Field of the Invention

The present invention relates to a manufacturing method of a solid-state battery.

### Related Art

In recent years, secondary batteries that contribute to energy efficiency have been researched and developed to ensure that more people have access to affordable, reliable, sustainable, and advanced energy.

As a method of automatically manufacturing a secondary battery with good productivity, a method has been known which feeds the materials of a positive electrode layer, a negative electrode layer, etc. by way of rolls, and cuts the materials in an overlapped state.

Patent Document 1: Japanese Unexamined Patent Application, Publication No. 1999-288733

### SUMMARY OF THE INVENTION

A manufacturing method of a solid-state battery for which dimensional control is simple has been sought when manufacturing a secondary battery having a plurality of layers including a solid electrolyte layer.

A first aspect of the present invention relates to a manufacturing method of a solid-state battery (for example, the solid-state battery 1) including: a negative electrode-side sheet member forming step (for example, the negative electrode-side sheet member forming step S40) of forming a negative electrode-side sheet member (for example, the negative electrode-side sheet member 400) that at least includes a negative electrode current collector (for example, the negative electrode current collector foil 221) and a negative electrode-side solid electrolyte layer (for example, the negative electrode-side solid electrolyte layer SE3); a positive electrode-side sheet member forming step (for example, the positive electrode-side sheet member forming step S30) of forming a positive electrode-side sheet member (for example, the positive electrode-side sheet member 300) that at least includes a positive electrode current collector (for example, the positive electrode current collector foil 321) and a positive electrode active material layer (for example, the positive electrode active material layer 31); and an integrating step (for example, the integrating pressing step S9) of laminating and integrating the negative electrode-side sheet member and the positive electrode-side sheet member, the negative electrode-side sheet member forming step includes: a negative electrode-side solid electrolyte layer transferring step (for example, the negative electrode-side solid electrolyte layer transferring step S6) of at least pressing and transferring the negative electrode-side solid electrolyte layer to the negative electrode current collector, and a negative electrode-side sheet member cutting step (for example, the negative electrode-side sheet member cutting step S7) of cutting a sheet-shaped member obtained by transferring, in which the positive electrode-side sheet member forming step includes: a positive electrode pressing step (for example, the positive electrode pressing step S3) of at least pressing a positive electrode current collector and a positive electrode active material layer, in which a first solid electrolyte layer (for example, the first solid electrolyte layer SE1) is provided to a surface of the positive electrode-side sheet member opposing the negative electrode-side solid electrolyte layer prior to the integrating step, and the negative electrode-side solid electrolyte layer has a smaller content of binder than the first solid electrolyte layer.

According to a second aspect of the present invention, it is preferable for a maximum value for a pressing pressure in the positive electrode pressing step to be at least equal to or greater than a maximum value for a pressing pressure in the negative electrode-side solid electrolyte layer transferring step.

According to a third aspect of the present invention, it is preferable for the positive electrode-side sheet member to be pressed two or more times.

According to a fourth aspect of the present invention, it is preferable for the positive electrode-side sheet member to have a greater thickness in a lamination direction than the negative electrode-side sheet member.

According to a fifth aspect of the present invention, it is preferable to further include, prior to the integrating step, a second solid electrolyte layer transferring step (for example, the second solid electrolyte layer transferring step S4) of laminating and transferring a second solid electrolyte layer (for example, the second solid electrolyte layer SE2) having a greater content of the binder than the negative electrode-side solid electrolyte layer, between the negative electrode-side solid electrolyte layer and the first solid electrolyte layer.

According to a sixth aspect of the present invention, it is preferable for the negative electrode-side sheet member to include a negative electrode active material layer (for example, the negative electrode active material layer 21).

According to a seventh aspect of the present invention, it is preferable to further include an intermediate layer transferring step (for example, the intermediate layer transferring step S5) of laminating and transferring an intermediate layer (for example, the intermediate layer 5) onto a negative electrode layer (for example, the negative electrode layer 2) including the negative electrode current collector.

According to the above first aspect, since the negative electrode-side solid electrolyte layer has a smaller amount of binder than the first solid electrolyte layer, the negative electrode-side sheet member having the negative electrode-side solid electrolyte layer is easily cut. For this reason, the cutting of the negative electrode-side sheet member, and then laminating and transferring to the positive electrode-side sheet member is facilitated, and thus it becomes easy to control the dimensions to the desired design dimensions.

According to the above second aspect, since the positive electrode-side sheet member contains the binder more abundantly than the negative electrode-side sheet member, it becomes pressable at higher pressure than the negative electrode-side sheet member. By conveying the positive electrode-side sheet member without cutting, and integrating with the cut negative electrode-side sheet member, it thereby becomes possible to efficiently manufacture the solid-state battery 1.

According to the above third aspect, since the positive electrode-side sheet member contains the binder more abundantly than the negative electrode-side sheet member, it becomes possible to press multiple times. By pressing multiple times, the electrode becomes compact, and it is possible to form so as to have high energy density.

According to the above fourth aspect, to enhance the energy density, the positive electrode-side sheet member abundantly contains the positive electrode active material layer 31 and is formed to be thick. For this reason, by conveying the positive electrode-side sheet member without cutting, and integrating with the negative electrode-side sheet member obtained by cutting, it becomes possible to efficiently manufacture the solid-state battery 1.

According to the above fifth aspect, by including the second solid electrolyte layer between the negative electrode-side solid electrolyte layer and the first solid electrolyte layer SE1, it becomes easier to stably adhere the negative electrode-side solid electrolyte layer having a relatively small amount of the binder, and the first solid electrolyte layer via the second solid electrolyte layer.

According to the above sixth aspect, it becomes possible to provide a solid-state battery of high energy density.

According to the above seventh aspect, in the case of the solid-state battery 1 being a lithium metal battery, it thereby becomes possible to uniformly precipitate lithium metal, which can stabilize the interface between the intermediate layer and the solid electrolyte layer.

### BRIEF DESCRIPTION OF THE DRAWINGS

FIG. 1 is a view showing a cross-section of a solid-state battery according to the present embodiment;

FIG. 2 is a view showing a manufacturing system of a solid-state battery according to the present embodiment;

FIG. 3 is a view showing a part of the manufacturing system of a solid-state battery according to the present embodiment;

FIG. 4 is a view showing the flow of the manufacturing method of a solid-state battery according to the present embodiment;

FIG. 5 is a view for explaining positions at which cutting each layer constituting the solid-state battery according to the present embodiment;

FIG. 6A is a view for explaining the precision of dimensions of layers constituting a positive electrode-side sheet member according to the present embodiment; and

FIG. 6B is a view for explaining the precision of dimensions of layers constituting a negative electrode-side sheet member according to the present embodiment.

### DETAILED DESCRIPTION OF THE INVENTION

### Solid-State Battery

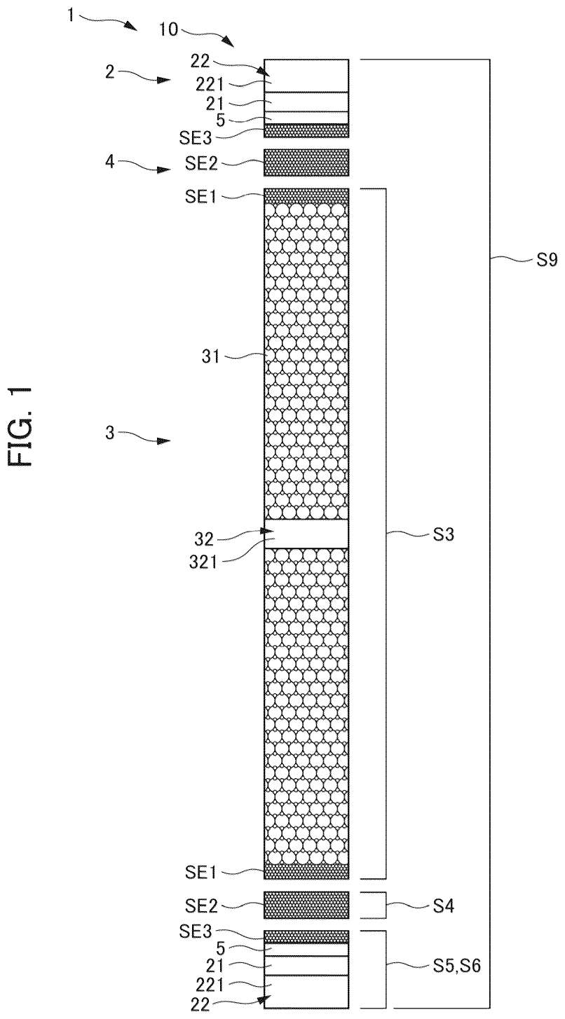

A solid-state battery 1 manufactured by a manufacturing method according to the present invention is an all solid-state battery including an electrode 10 in which a negative electrode layer 2, a solid electrolyte layer 4, and a positive electrode layer 3 are laminated in this order, as shown in FIG. 1. In the present embodiment, a structure in which the negative electrode layer 2, the solid electrolyte layer 4, the positive electrode layer 3, the solid electrolyte layer 4 and the negative electrode layer 2 are laminated in this order as shown in FIG. 1 will be described as a laminate structure of the solid-state battery 1. However, the structure of the solid-state battery 1 is not limited to the above. The solid-state battery 1 may have configurations which can be used in a solid-state battery such as an outer jacket, in addition to the electrode 10 shown in FIG. 1.

The solid electrolyte layer 4 of the solid-state battery 1 at least includes a first solid electrolyte layer SE1 arranged on the side of the positive electrode layer 3, and a negative electrode-side solid electrolyte layer SE3 arranged on the side of the negative electrode layer 2. The solid electrolyte layer 4 may include a second solid electrolyte layer SE2 arranged adjacent to the first solid electrolyte layer SE1. The present embodiment describes a configuration in which the solid electrolyte layer 4 consisting of three or more of the above layers. An intermediate layer 5 may be optionally arranged between the negative electrode layer 2 and the solid electrolyte layer 4.

The solid-state battery 1 is not particularly limited; however, it may be a lithium ion solid secondary battery, or a lithium metal secondary battery.

### Negative Electrode Layer

The negative electrode layer 2 includes a negative electrode active material layer 21 and a negative electrode current collector layer 22. The negative electrode active material layer 21 is not particularly limited, and can be configured from materials which can be used as the negative electrode active material of the solid-state battery 1. As examples of the negative electrode active material constituting the negative electrode active material layer 21, lithium metal, lithium alloy, Si, silicon-based active materials such as Si alloys, lithium transition metal oxides such as lithium titanate (Li₄Ti₅O₁₂), transition metal oxides such as TiO₂, Nb₂O₃ and WO₃, metal sulfides, metal nitrides, carbon materials such as graphite, soft carbon and hard carbon, metal indium and the like can be exemplified.

The negative electrode active material layer 21 may include materials which can be contained in the negative electrode active material layer 21 of the solid-state battery 1 other than those mentioned above. As the above-mentioned materials, for example, a solid electrolyte, a conductive auxiliary agent, a binder, etc. can be exemplified. As the solid electrolyte, those similar to the solid electrolyte contained in the solid electrolyte layer 4 described later can be exemplified. As the conductive auxiliary agent, carbon black, natural graphite, carbon fiber, carbon nanotubes, etc. can be exemplified. As the binder, nitrile polymers, polyester polymers, acrylic acid polymers, cellulose polymers, styrene polymers, styrene butadiene polymers, vinyl acetate polymers, urethane polymers, fluoroethylene polymers, and the like can be exemplified.

The negative electrode current collector layer 22 is not particularly limited; however, it can be configured from copper, nickel, stainless steel or the like. As the form of the negative electrode current collector layer 22, for example, foil, plate, mesh, non-woven fabric, foam and the like can be exemplified. In the present embodiment, the negative electrode current collector layer 22 is configured from a negative electrode current collection foil 221 as the negative electrode current collector.

### Solid Electrolyte Layer

The solid electrolyte layer 4 is formed between the negative electrode layer 2 and the positive electrode layer 3. The solid electrolyte layer 4, in the present embodiment, has a structure in which the first solid electrolyte layer SE1 arranged to abut the positive electrode layer 3, the second solid electrolyte layer SE2, and the negative-electrode-side solid electrolyte layer SE3 arranged on the side of the negative electrode layer 2 are laminated in this order.

The first solid electrolyte layer SE1 is arranged to abut the positive electrode active material layer 31 of the positive electrode layer 3. The solid electrolyte constituting the first solid electrolyte layer SE1 is not particularly limited, and is sufficient so long as a material which can be used as the electrolyte of a solid-state battery. For example, a sulfide solid electrolyte, an oxide solid electrolyte, a halide solid electrolyte, an inorganic solid electrolyte of a lithium-containing salt or the like, and a polymer-based solid electrolyte of polyethylene oxide or the like can be exemplified. The above-mentioned solid electrolytes may be used independently, or may be used by combining two or more types thereof.

A binder is included in the first solid electrolyte layer SE1, in addition to the solid electrolyte material. As the binder, a substance similar to the binders which can be contained in the negative electrode active material layer 21 can be used. The content of binder in the first solid electrolyte layer SE1 relative to the overall mass of the first solid electrolyte layer SE1 is equal to or greater than the content of the binder in the second solid electrolyte layer SE2 relative to the overall mass of the second solid electrolyte layer SE2. The upper limit for the content of the above binder in the first solid electrolyte layer SE1, for example, is 25% by mass. The content of the above binder in the first solid electrolyte layer SE1 is preferably 10 to 30% by mass. The first solid electrolyte layer SE1 thereby tends to stretch to follow the positive electrode layer 3 during pressing of the positive electrode layer 3. In addition, it is possible to reduce the pressing pressure in a transfer pressing step described later.

In addition to the solid electrolyte material and the binder, materials that can be used in the solid electrolyte layer of a solid-state battery may be contained in the first solid electrolyte layer SE1.

The thickness of the first solid electrolyte layer SE1 (length in lamination direction of each layer) is preferably thinner than the thickness of the second solid electrolyte layer SE2. The thickness of the first solid electrolyte layer SE1 is preferably 3 to 15 μm, for example.

The second solid electrolyte layer SE2 is a layer which is optionally arranged, and is arranged adjacent to the first solid electrolyte layer SE1. The solid electrolyte material constituting the second solid electrolyte layer SE2 is not particularly limited, and it is possible to establish as a material similar to the solid electrolyte material constituting the first solid electrolyte layer SE1. The second solid electrolyte layer SE2 may contains a binder, etc. other than the solid electrolyte material, similarly to the first solid electrolyte layer SE1. The content of the above-mentioned binder in the second solid electrolyte layer SE2 is equal to or less than the content of the above-mentioned binder in the first solid electrolyte layer SE1. The content of the above-mentioned binder in the second solid electrolyte layer SE2 is preferably 10 to 30% by mass. It is thereby possible to improve the energy density of the solid-state battery 1. The second solid electrolyte layer SE2 may contain a support medium. The support medium may be a three-dimensional structure of a mesh, a woven fabric, a non-woven fabric, an embossed material, a perforated material, an expanded material, foam or the like. The second solid electrolyte layer SE2 may not necessarily contain the above-mentioned support body.

The thickness of the second solid electrolyte layer SE2 (length in lamination direction of each layer) is preferably thicker than the thickness of the first solid electrolyte layer SE1. In addition, the thickness of the second solid electrolyte layer SE2 (length in lamination direction of each layer) is preferably thicker than the thickness of the negative electrode-side solid electrolyte layer SE3 described later. The thickness of the second solid electrolyte layer SE2 is preferably 10 to 50 μm, for example.

The negative electrode-side solid electrolyte layer SE3 is arranged on the side of the negative electrode layer. The negative electrode-side solid electrolyte layer SE3 is arranged adjacent to the negative electrode layer 2. The negative electrode-side solid electrolyte layer SE3, in the case of the solid-state battery 1 having an intermediate layer 5 as shown in FIG. 1, may be arranged adjacent to the intermediate layer 5.

The solid electrolyte material constituting the negative electrode-side solid electrolyte layer SE3 is not particularly limited, and can be established as a material similar to the solid electrolyte material constituting the first solid electrolyte layer SE1. The content of the above-mentioned binder in the negative electrode-side solid electrolyte layer SE3 is preferably 1.3 to 8.7% by mass. By volume percent, the content of the above-mentioned binder in the negative electrode-side solid electrolyte layer SE3 is preferably 2.7% by volume or more and 10% by volume or less. The content of the above-mentioned binder in the negative electrode-side solid electrolyte layer SE3 is less than the content of the above-mentioned binder in the first solid electrolyte layer SE1.

The thickness of the negative electrode-side solid electrolyte layer SE3 (length in lamination direction of each layer) is preferably thinner than the thickness of the second solid electrolyte layer SE2. The thickness of the negative electrode-side solid electrolyte layer SE3 is preferably 3 to 8.5 μm, for example.

### Positive Electrode Layer

The positive electrode layer 3 includes a positive electrode active material layer 31 and a positive electrode current collector layer 32. In the present embodiment, the positive electrode layer 3 has a configuration in which two positive electrode active material layers 31 are laminated on both sides of one positive electrode current collector layer 32. On the other hand, the configuration of the positive electrode layer 3 is not limited to the above, and may have the configuration in which one positive electrode active material layer 31 is laminated on one side of one positive electrode current collector layer 32.

The positive electrode active material layer 31 is not particularly limited, and can be configured from substances which can be used as the positive electrode active material of a solid-state battery. Examples of the positive electrode active material constituting the positive electrode active material layer 31 include: layered positive electrode active material particles such as of LiCoO₂, LiNiO₂, LiCoₓNi_{y}Mn_{z}O₂ (x+y+z=1), LiVO₂ and LiCrO₂; spinel-type positive electrode active materials such as LiMn₂O₄, Li(Ni_{0.25}Mn_{0.75})₂O₄, LiCoMnO₄, and Li₂NiMn₃O₈; olivine-type positive electrode active materials such as LiCoPO₄, LiMnPO₄ and LiFePO₄; solid solution oxides (Li₂MnO₃—LiMO₂ (M=Co, Ni, etc.)); conductive polymers such as polyaniline and polypyrrole; sulfides such as Li₂S, CuS, Li—Cu—S compounds, TiS₂, FeS, MoS₂, and Li—Mo—S compounds; mixtures of sulfur and carbon, etc. can be exemplified. The above-mentioned positive electrode active material may use one type of the above materials, or may be a configuration consisting of two or more types of the above materials.

The positive electrode active material layer 31 may contain a binder, etc. The content of the binder in the positive electrode active material layer 31 is preferably 0.5 to 5% by mass. It may preferably be 2.56% by mass. The thickness of the positive electrode active material layer 31 (length in lamination direction of each layer) is preferably 80 to 100 μm, for example. It is thereby possible to improve the battery capacity of the solid-state battery 1.

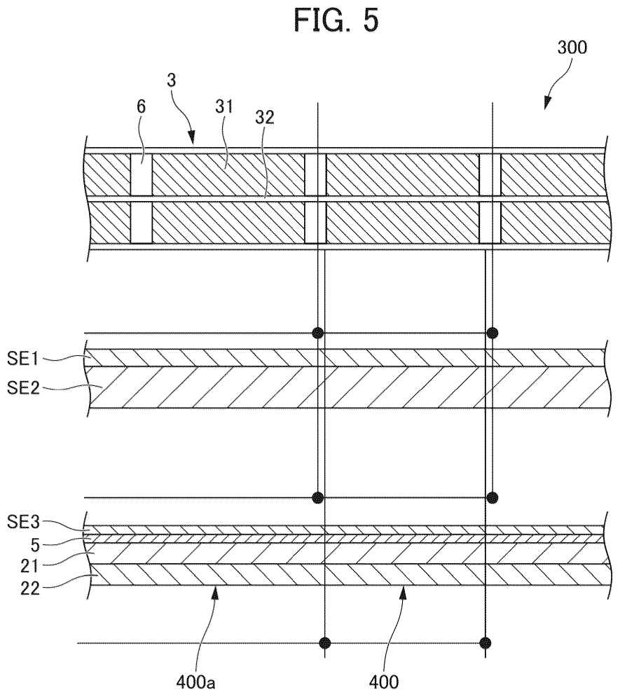

An insulating frame 6 may be provided at the outer peripheral portion of the positive electrode active material layer 31, as shown in FIG. 5. It is possible to prevent short-circuit of the solid-state battery 1, and improve the strength by way of the insulating frame 6. In the completed state of the solid-state battery 1, the insulating frame 6 is arranged so as to cover a lateral face of the two positive electrode active material layers 31 formed on both sides of the positive electrode current collector layer 32. The material constituting the insulating frame 6 is not particularly limited; however, for example, insulating oxides such as alumina, resins such as polyvinylidene fluoride (PVDF), rubbers such as styrene butadiene rubber (SBR) and the like can be exemplified.

The positive electrode current collector layer 32 is not particularly limited; however, for example, it can be configured from aluminum, stainless steel, conductive carbon (graphite, carbon nanotubes, etc.), or the like. As the form of the positive electrode current collector layer 32, for example, foil, plate, mesh, non-woven fabric, foam and the like can be exemplified. In the present embodiment, the positive electrode current collector layer 32 is configured from the positive electrode current collector foil 321 as the positive electrode current collector.

### Intermediate Layer

The intermediate layer 5 is arranged between the negative electrode layer 2 and the solid electrolyte layer 4. The intermediate layer 5, for example, in the case of the solid-state battery 1 being a lithium metal battery, has a function of uniformly precipitating lithium metal. Therefore, the interface between the intermediate layer 5 and the solid electrolyte layer 4 stabilizes. In the case of the solid-state battery 1 being a lithium metal secondary battery that includes the intermediate layer 5, the solid-state battery 1 may be an anode-free battery in which the negative electrode active material layer 21 is not present during the initial charging. In this case, after the initial charge/discharge, a lithium metal layer is formed as the negative electrode active material layer 21.

The substance constituting the intermediate layer 5 is not particularly limited; however, for example, a metal capable of alloying with lithium, amorphous carbon or the like can be exemplified. As the metal capable of alloying with lithium, for example, tin (Sn), silicon (Si), zinc (Zn), magnesium (Mg), gold (Au), platinum (Pt), palladium (Pd), silver (Ag), aluminum (Al), bismuth (Bi), antimony (Sb) and the like can be exemplified. The metal capable of alloying with lithium may be nanoparticles. As the amorphous carbon, for example, carbon blacks such as acetylene black, furnace black, and Ketjen black, coke, activated carbon and the like can be exemplified. The amorphous carbon may be easily graphitizable carbon (soft carbon), or may be hardly graphitizable carbon (hard carbon), CNT (carbon nanotubes), fullerene, or graphene. The intermediate layer may include a binder in addition to the above substances.

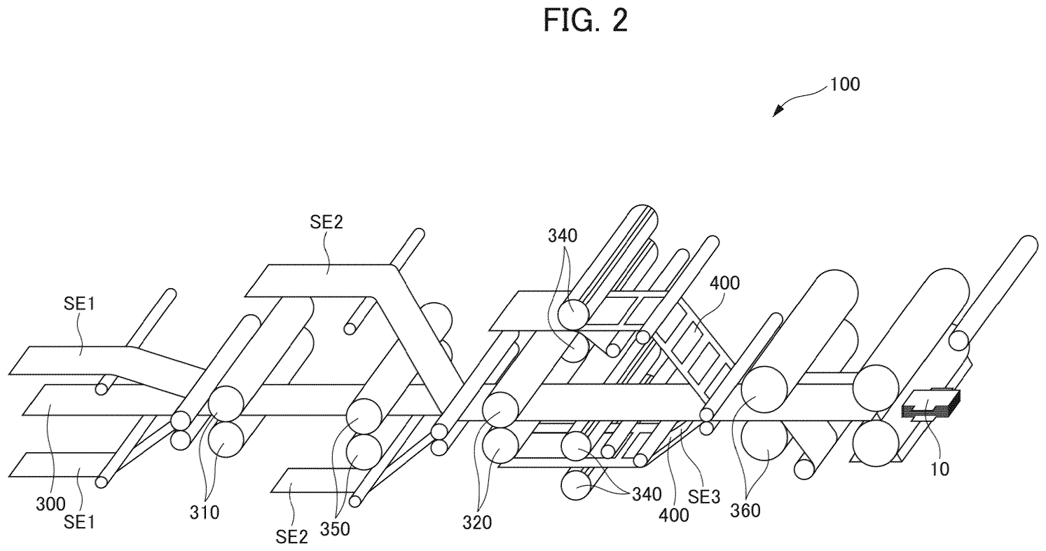

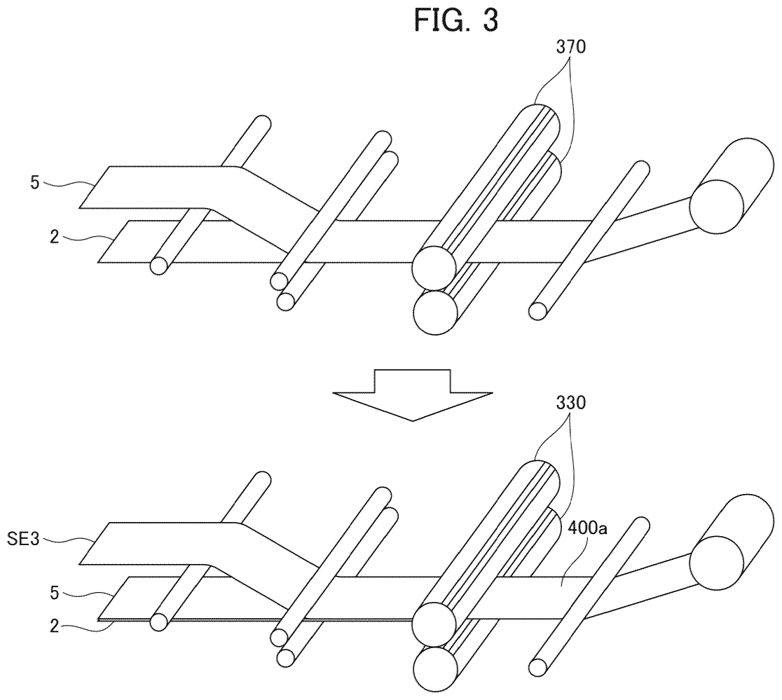

A manufacturing system 100 for manufacturing the above solid-state battery 1 will be described. FIG. 2 shows the manufacturing system 100 of the solid-state battery 1 according to the present embodiment. The manufacturing system 100 includes first positive electrode-side transfer rollers 310, second positive electrode-side transfer rollers 320, intermediate layer transfer rollers 370 (refer to FIG. 3), negative electrode-side transfer rollers 330 (refer to FIG. 3), negative electrode-side sheet member lamination rollers 340, positive electrode press device 350, and integrating press device 360, and manufactures the solid-state battery 1 continuously, while feeding a positive electrode-side sheet member 300 in one direction by each of the above rollers. It should be noted that FIG. 1 shows the pressed or transfer pressed areas in a positive electrode pressing step S3, a second solid electrolyte layer transferring step S4, an intermediate layer transferring step S5, a negative electrode-side solid electrolyte layer transferring step S6 and an integrating pressing step S9 as an integrating step, which are described later.

The positive electrode-side sheet member 300 is a sheet-shaped member obtained by the positive electrode active material layer 31 being laminated on the positive electrode current collector foil 321 constituting the positive electrode current collector layer 32. The positive electrode-side sheet member 300 constitutes the positive electrode layer 3 of the solid-state battery 1 after manufacture. The positive electrode-side sheet member 300 is fed by rollers (not shown), and conveyed so as to continuously extend from a base end side until a terminal end of the production line of the solid-state battery 1.

The first positive electrode-side transfer rollers 310, the second positive electrode-side transfer rollers 320, the intermediate layer transfer rollers 370, the negative electrode-side transfer rollers 330 and the negative electrode-side sheet member lamination rollers 340 are each configured by a pair of rotating rollers. These first positive electrode-side transfer rollers 310, second positive electrode-side transfer rollers 320, intermediate layer transfer rollers 370 and negative electrode-side transfer rollers 330 perform transfer pressing of a sheet serving as a substrate or the like on a side to which transferred and a sheet on which a transferring solid electrolyte layer, etc. are provided, by sandwiching between the pairs of rollers and passing therethrough while pressurizing. The negative electrode-side sheet member lamination rollers 340 position the sheet sandwiched therebetween while passing therethrough.

The positive electrode press device 350 and integrating press device 360 are each configured by a pair of rotating rollers, similarly to the transfer rollers, and are devices which sandwich the positive electrode-side sheet member 300 in which the solid electrolyte layer, etc. are laminated according to the process between the pair of rollers and made to pass while being pressurized, and thereby perform densification.

These rollers, as shown in FIG. 2, are aligned along the feed direction of the positive electrode-side sheet member 300 in the order of the first positive electrode-side transfer rollers 310, positive electrode press device 350, second positive electrode-side transfer rollers 320, negative electrode-side sheet member lamination rollers 340 and integrating press device 360, from the upstream side. The second positive electrode-side transfer rollers 320, in the case of the solid-state battery 1 having the second solid electrolyte layer SE2, is arranged between the positive electrode press device 350 and the negative electrode-side sheet member lamination rollers 340.

The intermediate layer transfer rollers 370 and the negative electrode-side transfer rollers 330 are arranged to be spaced from a feed line L of the positive electrode-side sheet member 300, and perform transfer pressing of the intermediate layer 5 or the negative electrode-side solid electrolyte layer SE3. Thereafter, as described later, the formed intermediate layer 5 and negative electrode layer 2 are conveyed to the upper surface side or lower surface side of the positive electrode-side sheet member 300, merge at the feed line L of the positive electrode-side sheet member 300, and are laminated by the negative electrode-side sheet member lamination rollers 340.

The manufacturing method of the solid-state battery 1 by the above manufacturing system 100 of the solid-state battery 1 will be described. The manufacturing method of the solid-state battery 1 includes a positive electrode-side sheet member forming step S30, and a negative electrode-side sheet member forming step S40. The positive electrode-side sheet member forming step S30 is a step of forming the positive electrode-side sheet member 300 including at least the positive electrode current collector foil 321 which is the positive electrode current collector layer, and the positive electrode active material layer 31, and includes a positive electrode-side sheet member feeding step S1, a first solid electrolyte layer transferring step S2, a positive electrode pressing step S3 and a second solid electrolyte layer transferring step S4 described later. The negative electrode-side sheet member forming step S40 is a step of forming the negative electrode-side sheet member including at least the negative electrode current collector foil 221 which is the negative electrode current collector, and the negative electrode-side solid electrolyte layer SE3, and includes an intermediate layer transferring step S5, a negative electrode-side solid electrolyte layer transferring step S6 and a negative electrode-side sheet member cutting step S7 described later.

First, the positive electrode-side sheet member 300 made by coating and laminating the positive electrode active material on the positive electrode current collector foil 321 constituting the positive electrode current collector layer 32 is conveyed to be fed by conveyance rollers (not shown) (positive electrode-side sheet member feeding step S1).

It should be noted that, as shown in FIG. 5, in the positive electrode-side sheet member 300, the insulating frame 6 is formed according to the design dimensions after completion of the solid-state battery 1, on the positive electrode current collector foil 321. The insulating frame 6 is arranged in a frame shape, and the positive electrode active material layer 31 is coated intermittently to be arranged within this frame.

Next, the first solid electrolyte layer SE1 is transferred to the positive electrode-side sheet member 300 by the first positive electrode-side transfer rollers 310 (first solid electrolyte layer transferring step S2). The first solid electrolyte layer transferring step S2 includes a positioning step S21 and a transfer pressing step S22. In the positioning step S21, the first solid electrolyte layer SE1 is positioned on the positive electrode-side sheet member 300 so as to be arranged within an area guided by guide rollers (not shown). In the transfer pressing step S22, a slurry constituting the first solid electrolyte layer SE1 is made to pass while pressurizing by the first positive electrode-side transfer rollers 310 serving as the transfer rollers on the positive electrode-side sheet member 300 to perform transfer pressing. For the pressure at this time, for example, the pressure at room temperature (e.g., 10 to 35° C.) can be set to 50 to 500 MPa. Preferably, it may be 100 MPa at 25° C.

Next, the positive electrode-side sheet member 300 to which the first solid electrolyte layer SE1 was transferred is pressed by the positive electrode press device 350 (positive electrode pressing step S3). The positive electrode is densified by this positive electrode pressing step S3. For densifying, the pressure of the press is on the order of 800 to 1200 MPa at 25 to 100 degrees. A laminate body of the densified positive electrode-side sheet member 300 and the first solid electrolyte layer SE1 is conveyed to the downstream direction of the feed line L.

After the positive electrode pressing step S3, the second solid electrolyte layer SE2 is transferred onto the positive electrode-side sheet member 300 on which the first solid electrolyte layer SE1 was transferred and pressed, by the second positive electrode-side transfer rollers 320 (second solid electrolyte layer transferring step S4). The second solid electrolyte layer transferring step S4 includes a positioning step S41 and a transfer pressing step S42. In the positioning step S41, the second solid electrolyte layer SE2 is positioned on the positive electrode-side sheet member 300 to which the first solid electrolyte layer SE1 was transferred so as to be arranged within the area guided by the guide rollers (not shown). In the transfer pressing step S42, the slurry constituting the second solid electrolyte layer SE2 is made to pass while pressurizing by the second positive electrode-side transfer roller 320 serving as the transfer roller on the positive electrode-side sheet member 300 to perform transfer pressing. For the pressure at this time, the pressure at room temperature (e.g., 10 to 35° C.) can be set to 50 to 500 MPa. Preferably, it may be 150 MPa at 25° C.

On the other hand, a negative electrode-side sheet member 400 is prepared at a position separated from the feed line L. First, as shown at the upper part of FIG. 3, the intermediate layer 5 is transferred by the intermediate layer transfer rollers 370 onto the negative electrode layer 2 configured by the negative electrode active material layer 21 laminated on the negative electrode current collector foil 221 (intermediate layer transferring step S5). Then, as shown in the lower part of FIG. 3, the negative electrode-side solid electrolyte layer SE3 is transferred onto the intermediate layer 5 by the negative electrode-side transfer rollers 330 to form the negative electrode-side sheet member 400 (negative electrode-side solid electrolyte layer transferring step S6). According to this sequence, the intermediate layer 5 becomes arranged between the negative electrode active material layer 21 and the negative electrode-side solid electrolyte layer SE3.

The intermediate layer transferring step S5 includes an intermediate layer positioning step S51, and an intermediate layer transfer pressing step S52. In the intermediate layer positioning step S51, the slurry constituting the intermediate layer 5 is positioned on the negative electrode active material layer 21 so as to be arranged within an area guided by guide rollers (not shown). In the intermediate layer transfer pressing step S52, the intermediate layer 5 is made to pass while pressurizing on the negative electrode active material layer 21 by the intermediate layer transfer rollers 370 serving as the transfer rollers to perform intermediate layer transfer pressing to transfer the intermediate layer 5 to the negative electrode active material layer 21. For the pressure at this time, the pressure at room temperature (e.g., 10 to 35° C.) can be set to 50 to 800 MPa, and more preferably is within the range of 300 MPa or more and 800 MPa or less at 25° C.

The negative electrode-side solid electrolyte layer transferring step S6 includes a negative electrode-side solid electrolyte layer positioning step S61, and a negative electrode-side solid electrolyte layer transfer pressing step S62. In the negative electrode-side solid electrolyte layer positioning step S61, the slurry constituting the negative electrode-side solid electrolyte layer SE3 is positioned on the intermediate layer 5 so as to be arranged within an area guided by the guide rollers (not shown). In the negative electrode-side solid electrolyte layer transfer pressing step S62, the negative electrode-side solid electrolyte layer SE3 is made to pass while pressurizing by the negative electrode-side transfer roller 330 as the transfer roller on the intermediate layer 5 to perform the negative electrode active material layer transfer pressing to transfer the negative electrode-side solid electrolyte layer SE3 to the intermediate layer 5. A sheet-shaped member 400a in which the negative electrode layer 2, the intermediate layer 5 and the negative electrode-side solid electrolyte layer SE3 are laminated is thereby obtained. For the pressure at this time, the pressure at room temperature (e.g., 10 to 35° C.) can be set to 600 to 800 MPa.

Regarding the pressure, the pressure of pressing in the positive electrode pressing step S3 is not merely the maximum value of the pressure pressurizing the positive electrode-side sheet member 300, but is also the maximum value of the pressurizing pressure of the entire manufacturing method of the solid-state battery 1. The positive electrode-side sheet member 300 is pressed at high pressure in order to raise the energy density, and densify the electrode. The maximum value for the pressure in pressing of the positive electrode pressing step S3 is equal to or greater than the maximum value of the pressing pressure at which pressing the negative electrode-side sheet member 400.

In addition, the pressure upon transferring in the first solid electrolyte layer transferring step S2 and the second solid electrolyte layer transferring step S4 is smaller than the pressure of pressing in the positive electrode pressing step S3. In addition, the pressure upon transferring in the first solid electrolyte layer transferring step S2 and the second solid electrolyte layer transferring step S4 is smaller than the pressure of pressing in the negative electrode-side solid electrolyte layer transferring step S6.

Since relatively abundant binder is contained in the first solid electrolyte layer SE1 and the second solid electrolyte layer SE2, it is possible to reduce the pressing pressure upon transferring. In addition, by setting the pressing pressure in transferring to be as low as possible, it is possible to reduce the stretching amount of the first solid electrolyte layer SE1 and the second solid electrolyte layer SE2 by the pressing of transfer. Therefore, it is possible to leave a margin for the first solid electrolyte layer SE1 and the second solid electrolyte layer SE2 to stretch later in the following integrating pressing step S9, etc., and the first solid electrolyte layer SE1 can be stretched to follow the positive electrode layer 3. It is thereby possible to improve the bondability of the first solid electrolyte layer SE1 with the positive electrode active material layer 31.

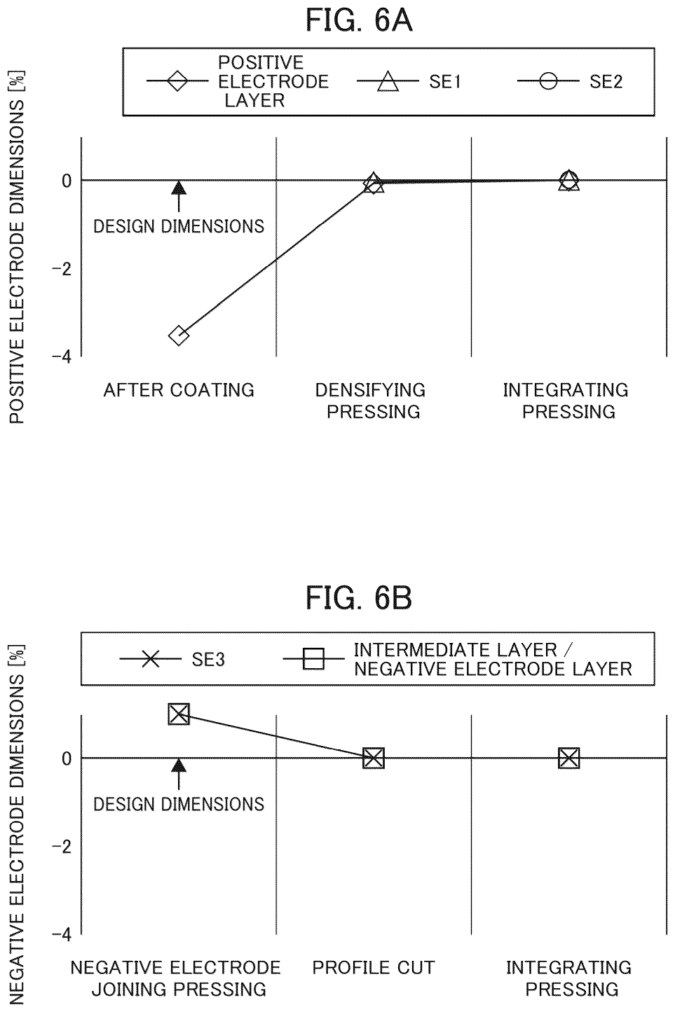

As shown in FIG. 6A, the positive electrode layer 3 of the positive electrode-side sheet member 300 (positive electrode current collector layer 32 and positive electrode active material layer 31), the first solid electrolyte layer SE1 and the second solid electrolyte layer SE2 are densified by the positive electrode pressing step S3 and/or integrating pressing step S9; therefore, they are pressed with high pressure so as to become the design dimensions at the stage of pressing.

After the negative electrode-side solid electrolyte layer transferring step S6, in a state in which the obtained negative electrode layer 2, intermediate layer 5 and negative electrode-side solid electrolyte layer SE3 are laminated, the continuous sheet-shaped member 400a is cut by a cutter while being supported on a discharge roll which discharges the member transferring in the negative electrode-side solid electrolyte layer transferring step S6 (negative electrode-side sheet member cutting step S7). The sheet-shaped member 400a is cut so as to become the design dimensions of the negative electrode layer 2 of the solid-state battery 1. As shown in FIG. 5, the sheet-shaped member 400a is cut to be slightly smaller than the dimension to which the positive electrode-side sheet member 300 is cut in the cutting step S10 described later for short-circuit prevention, whereby the negative electrode-side sheet member 400 is formed.

As shown in FIG. 6B, the negative electrode layer 2, the intermediate layer 5 and the negative electrode-side solid electrolyte layer SE3, due to having finer particles compared to the positive electrode layer 3, etc., and having a flexible nature, match the design dimensions by cutting in the negative electrode-side sheet member cutting step S7.

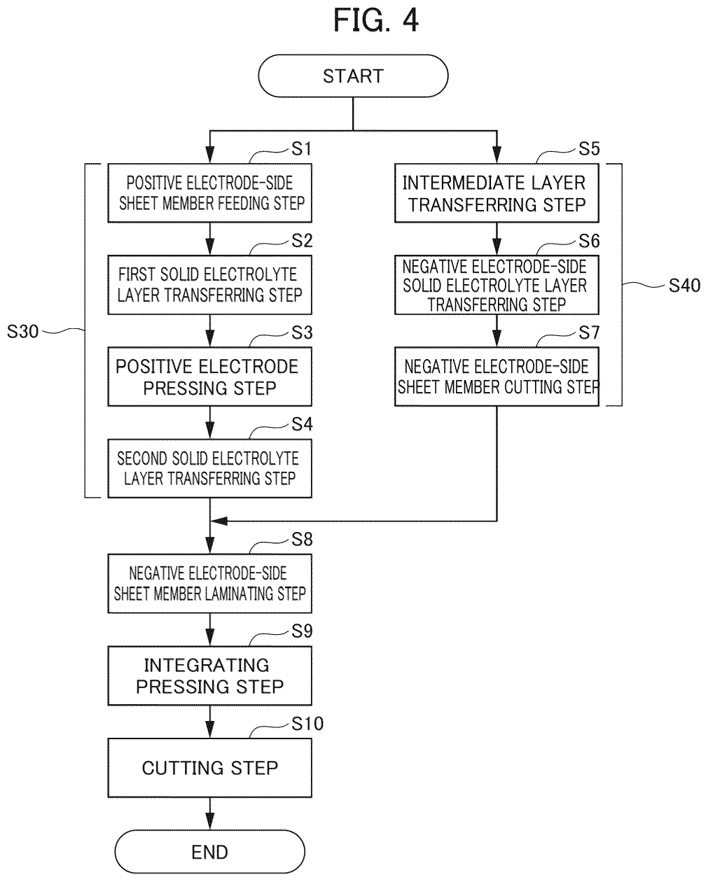

As shown in FIGS. 2 and 4, the negative electrode-side sheet member 400 cut to the design dimensions is conveyed to the positive electrode-side sheet member 300 so as to merge with the feed line L of the positive electrode-side sheet member 300, and is laminated on the positive electrode-side sheet member 300. At this time, prior to the integrating pressing step S9 described later, on a surface of the positive electrode-side sheet member 300 opposing the negative electrode-side solid electrolyte layer SE3, the first solid electrolyte layers SE1 is provided on a lower layer side, and the second solid electrolyte layer SE2 is provided thereon. Then, on this, the negative electrode-side sheet member 400 in the cut state is arranged on the positive electrode-side sheet member 300. In more detail, on the positive electrode-side sheet member 300 to which the first solid electrolyte layer SE1 and the second solid electrolyte layer SE2 were transferred, the negative electrode-side sheet member 400 to which the negative electrode-side solid electrolyte layer SE3 was transferred is conveyed and laminated by the negative electrode-side sheet member lamination rollers 340 (negative electrode-side sheet member laminating step S8). In the negative electrode-side sheet member laminating step S8, the negative electrode-side sheet member 400 cut to the design dimensions is positioned on the positive electrode-side sheet member 300 to which the first solid electrolyte layer SE1 and the second solid electrolyte layer SE2 were transferred, so as to be arranged within an area guided by guide rollers (not shown).

By configuring in this way, the integrating press device 360 presses in a state in which the positive electrode-side sheet member 300 and the negative electrode-side sheet member 400 are laminated, so that the electrode 10 is integrated (integrating pressing step S9). In this way, the positive electrode-side sheet member 300 is pressed two or more times including the transferring step and the pressing step. Regarding the thicknesses in the lamination direction of the negative electrode-side sheet member 400 and the positive electrode-side sheet member 300 in the state immediately prior to the integrating pressing step S9, the thickness of the positive electrode-side sheet member 300 is greater than the thickness of the negative electrode-side sheet member 400. The pressure at this time, for example, is on the order of 500 to 900 MPa at 25 to 100 degrees. At the same time as the positive electrode-side sheet member 300 and the negative electrode-side sheet member 400 are being integrated, the first solid electrolyte layer SE1, the second solid electrolyte layer SE2 and the negative electrode-side solid electrolyte layer SE3 densify by way of the integrating pressing step S9. When comparing the pressing pressures of the integrating pressing step S9 and the positive electrode pressing step S3, the pressure of pressing in the positive electrode pressing step S3 is greater than the pressure of pressing in the integrating pressing step S9.

After the integrating pressing step S9, the formed electrode 10 is cut by a rotary cutter (cutting step S10).

Transferring of the first solid electrolyte layer SE1 in the first solid electrolyte layer transferring step S2, pressing of the positive electrode-side sheet member 300 in the positive electrode pressing step S3, transferring of the second solid electrolyte layer SE2 in the second solid electrolyte layer transferring step S4, laminating before integration of the negative electrode-side sheet member 400 in the negative electrode-side sheet member laminating step S8, and integrating pressing in the integrating pressing step S9 are performed on both sides of the positive electrode-side sheet member 300 fed in the positive electrode-side sheet member feeding step S1. The solid-state battery 1 such as that shown in FIG. 1 in which each layer symmetrically laminated on both upper and lower sides is thereby obtained.

In addition, as mentioned above, the first solid electrolyte layer transferring step S2, the second solid electrolyte layer transferring step S4, the positive electrode pressing step S3, the negative electrode-side sheet member laminating step S8 and the integrating pressing step S9 are continuously performed on the positive electrode-side sheet member 300 fed in the positive electrode-side sheet member feeding step S1. The negative electrode-side sheet member forming step S40 is performed at a position separated from the positive electrode-side sheet member 300; however, the formed negative electrode-side sheet member 400 is arranged so as to merge with the positive electrode-side sheet member 300, whereby the manufacturing method of the solid-state battery 1 is formed by a series of continuous flows.

According to the present embodiment, the following effects are exerted.
(1) A manufacturing method of the solid-state battery 1 is configured to include: the negative electrode-side sheet member forming step S40 of forming the negative electrode-side sheet member 400 which at least includes the negative electrode current collector foil 221 and the negative electrode-side solid electrolyte layer SE3; the positive electrode-side sheet member forming step S30 of forming the positive electrode-side sheet member 300 which at least includes the positive electrode current collector foil 321 and the positive electrode active material layer 31; and the integrating pressing step S9 of laminating and integrating the negative electrode-side sheet member 400 and the positive electrode-side sheet member 300. The negative electrode-side sheet member forming step S40 is configured to include the negative electrode-side solid electrolyte layer transferring step S6 of obtaining a negative electrode-side laminate body by at least pressing the negative electrode current collector foil 221 and the negative electrode-side solid electrolyte layer SE3, and the negative electrode-side sheet member cutting step S7 of cutting the laminate body; and the positive electrode-side sheet member forming step S30 is configured to include the positive electrode pressing step S3 of at least pressing the positive electrode current collector foil 321 and the positive electrode active material layer 31. Prior to the integrating pressing step S9, the first solid electrolyte layer SE1 is provided to a surface of the positive electrode-side sheet member 300 opposing the negative electrode-side solid electrolyte layer SE3, and the negative electrode-side solid electrolyte layer SE3 is configured to have a smaller content of binder than the first solid electrolyte layer SE1. Since the negative electrode-side solid electrolyte layer SE3 has a smaller amount of binder than the first solid electrolyte layer SE1, the negative electrode-side sheet member 400 having the negative electrode-side solid electrolyte layer SE3 is easily cut. For this reason, the cutting of the negative electrode-side sheet member 400, and then laminating and transferring to the positive electrode-side sheet member 300 is facilitated, and thus it becomes easy to control the dimensions to the desired design dimensions.
(2) According to the present embodiment, the maximum value for the pressing pressure in the positive electrode pressing step S3 is configured to be at least equal to or greater than the maximum value for the pressing pressure of the negative electrode-side solid electrolyte layer transferring step S6. Since the positive electrode-side sheet member 300 contains the binder more abundantly than the negative electrode-side sheet member 400, it becomes pressable at higher pressure than the negative electrode-side sheet member 400. By conveying the positive electrode-side sheet member 300 without cutting, and integrating with the cut negative electrode-side sheet member 400, it thereby becomes possible to efficiently manufacture the solid-state battery 1.
(3) According to the present embodiment, the positive electrode-side sheet member 300 is pressed two or more times. Since the positive electrode-side sheet member 300 contains the binder more abundantly than the negative electrode-side sheet member 400, it becomes possible to press multiple times. By pressing multiple times, the electrode becomes compact, and it is possible to form so as to have high energy density.
(4) According to the present embodiment, the positive electrode-side sheet member 300 is configured to have a greater thickness in the lamination direction than the negative electrode-side sheet member 400. To enhance the energy density, the positive electrode-side sheet member 300 abundantly contains the positive electrode active material layer 31 and is formed to be thick. For this reason, by conveying the positive electrode-side sheet member 300 without cutting, and integrating with the negative electrode-side sheet member 400 obtained by cutting, it becomes possible to efficiently manufacture the solid-state battery 1.
(5) According to the present embodiment, it is configured to include, prior to the integrating pressing step S9, the second solid electrolyte layer transferring step S4 of laminating and transferring the second solid electrolyte layer SE2 having a greater content of the binder than the negative electrode-side solid electrolyte layer SE3, between the negative electrode-side solid electrolyte layer SE3 and the first solid electrolyte layer SE1. By including the second solid electrolyte layer SE2 between the negative electrode-side solid electrolyte layer SE3 and the first solid electrolyte layer SE1, it becomes easier to stably adhere the negative electrode-side solid electrolyte layer SE3 having a relatively small amount of the binder, and the first solid electrolyte layer SE1 via the second solid electrolyte layer SE2.
(6) According to the present embodiment, the negative electrode-side sheet member 400 is configured to include the negative electrode active material layer 21. It thereby becomes possible to provide the solid-state battery 1 of high energy density.
(7) According to the present embodiment, it is configured to include the intermediate layer transferring step S5 of laminating and transferring the intermediate layer 5 onto the negative electrode layer 2 including the negative electrode current collector foil 221. In the case of the solid-state battery 1 being a lithium metal battery, it thereby becomes possible to uniformly precipitate lithium metal, which can stabilize the interface between the intermediate layer 5 and the solid electrolyte layer 4.

It should be noted that the present invention is not to be limited to the above-mentioned embodiment, and that modifications, improvements, etc. of a scope which can achieve the object of the present invention are also encompassed by the present invention. For example, in the above-mentioned embodiment, the negative electrode-side sheet member 400 includes a configuration in which the negative electrode current collector foil 221, negative electrode active material layer 21, intermediate layer 5 and negative electrode-side solid electrolyte layer SE3 are laminated; however, the negative electrode active material layer 21 and/or the intermediate layer 5 may not necessarily be included therein.

### EXPLANATION OF REFERENCE NUMERALS

1 solid-state battery
21 negative electrode active material layer
31 positive electrode active material layer
SE1 first solid electrolyte layer
SE2 second solid electrolyte layer
SE3 negative electrode-side solid electrolyte layer
400 negative electrode-side sheet member
S3 positive electrode pressing step
S5 intermediate layer transferring step
S6 negative electrode-side solid electrolyte layer transferring step
S7 negative electrode-side sheet member cutting step
S9 integrating pressing step (integrating step)
S40 negative electrode-side sheet member forming step
S30 positive electrode-side sheet member forming step

What is claimed is:

1. A manufacturing method of a solid-state battery comprising:
a negative electrode-side sheet member forming step of forming a negative electrode-side sheet member that at least includes a negative electrode current collector and a negative electrode-side solid electrolyte layer;
a positive electrode-side sheet member forming step of forming a positive electrode-side sheet member that at least includes a positive electrode current collector and a positive electrode active material layer; and
an integrating step of laminating and integrating the negative electrode-side sheet member and the positive electrode-side sheet member,
wherein the negative electrode-side sheet member forming step includes:
a negative electrode-side solid electrolyte layer transferring step of at least pressing and transferring the negative electrode-side solid electrolyte layer to the negative electrode current collector, and
a negative electrode-side sheet member cutting step of cutting a sheet-shaped member obtained by transferring,
wherein the positive electrode-side sheet member forming step includes:
a positive electrode pressing step of at least pressing a positive electrode current collector and a positive electrode active material layer,
wherein a first solid electrolyte layer is provided to a surface of the positive electrode-side sheet member opposing the negative electrode-side solid electrolyte layer prior to the integrating step, and
wherein the negative electrode-side solid electrolyte layer has a smaller content of binder than the first solid electrolyte layer.

2. The manufacturing method of a solid-state battery according to claim 1, wherein a maximum value for a pressing pressure in the positive electrode pressing step is at least equal to or greater than a maximum value for a pressing pressure in the negative electrode-side solid electrolyte layer transferring step.

3. The manufacturing method of a solid-state battery according to claim 1, wherein the positive electrode-side sheet member is pressed two or more times.

4. The manufacturing method of a solid-state battery according to claim 1, wherein the positive electrode-side sheet member has a greater thickness in a lamination direction than the negative electrode-side sheet member.

5. The manufacturing method of a solid-state battery according to claim 1, further comprising, prior to the integrating step, a second solid electrolyte layer transferring step of laminating and transferring a second solid electrolyte layer having a greater content of the binder than the negative electrode-side solid electrolyte layer, between the negative electrode-side solid electrolyte layer and the first solid electrolyte layer.

6. The manufacturing method of a solid-state battery according to claim 1, wherein the negative electrode-side sheet member includes a negative electrode active material layer.

7. The manufacturing method of a solid-state battery according to claim 1, further comprising an intermediate layer transferring step of laminating and transferring an intermediate layer onto a negative electrode layer including the negative electrode current collector.
